(19) United States
(12) Patent Application Publication
(10) Pub. No.: US 2006/0141860 A1
(43) Pub. Date: Jun. 29, 2006

(54) Mobile communication terminal having two separated body parts rotatable in horizontal direction by predetermined angle

(75) Inventor: Chun Won Lee, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: PANTECH CO., LTD.

(21) Appl. No.: 11/254,984

(22) Filed: Oct. 20, 2005

(30) Foreign Application Priority Data
Dec. 28, 2004 (KR) 10-2004-0114159

(51) Int. Cl. H01R 9/05

(52) U.S. Cl. 439/578

(57) ABSTRACT

A mobile communication terminal such as cellular phone or personal digital assistant (PDA) is separated into two body parts having functions different from each other and two body parts are connected to be rotatable in a horizontal direction by a predetermined angle so that a user can crook to use the terminal according to the user's taste. The mobile communication terminal can embody various functions of the terminal by providing an extended body portion, which is generated after the rotation of the predetermined angle, as an additional area in which functional elements required for a use of the terminal can be mounted.

### CROSS-REFERENCE TO RELATED APPLICATIONS

This application claims all benefits of Korean Patent Application No. 10-2004-0114159 filed on Dec. 28, 2004 in the Korean Intellectual Property Office, the disclosures of which are incorporated herein by reference.

### BACKGROUND OF THE INVENTION

1. Field of the Invention

The present invention relates to a mobile communication terminal such as cellular phone or personal digital assistant (PDA), and more particularly to a mobile communication terminal wherein the terminal is separated into two body parts having functions different from each other and two body parts are connected to be rotatable in a horizontal direction by a predetermined angle so that a user can crook to use the terminal according to the user's taste. In addition, the present invention relates to a mobile communication terminal capable of variously embodying functions of the terminal by providing an extended body portion, which is generated after the rotation of the predetermined angle, as an additional area in which functional elements required for a use of the terminal can be mounted.

2. Description of the Prior Art

A mobile communication terminal such as cellular phone or personal digital assistant (PDA) is typically provided with various functional elements having functions required for a use of the terminal, which occupy a predetermined area. An example of the functional elements includes a LCD screen, an input key button, a microphone, a speaker and the like. The functional elements are arranged in very diverse forms according to kinds and designs of the terminal.

For instance, a bar type terminal is generally provided with a LCD screen arranged at an upper part thereof and input key buttons arranged at a lower part thereof.

In addition, in a folder type terminal having a folder cover connected to be pivotable against a main body, navigation keys and number key buttons are typically arranged on the main body and a LCD screen is arranged on the folder cover.

Further, in a slide type terminal having a slide cover connected to be slidable against a main body, a LCD screen and navigation keys are typically arranged on an upper surface of the slide cover and number key buttons are arranged on an upper surface of the main body which is exposed when the slide cover is pushed up.

Since the functional elements are positively required so as to use the mobile communication terminal, any terminal should spare an area for arranging the functional elements.

As current mobile communication terminals pursue a light-thin-short-small type, it is considered to decrease sizes of the functional elements and to effectively arrange them. However, there are definite limits of the works.

Further, the current mobile communication terminal is being developed into a ‘portable digital complex machine’ or ‘portable multimedia complex machine’ having various functions and contents, including digital picture/moving picture photographing, multimedia reproduction/recording, game, internet, settlement and character message transfer in addition to the inherent voice call function.

Accordingly, in order to conveniently conduct the various contents, it has been required to add other functional elements in addition to the conventional functional elements and areas for arranging the additional functional elements have been also required additionally.

In the mean time, since the typical mobile communication terminal makes a straight, rectangular form even when the folder cover is opened or the slide cover is pushed up, the appearances of the terminal are uniform and simple, so that it is not possible to satisfy the various needs of a user.

In particular, since the bar type terminal simply has a bar shape, its appearance is plain and thus causes a dignity-degrading look. In addition, since both the LCD screen and the input key buttons should be arranged on the upper surface, a size of the terminal is obliged to be increased. Further, in the bar type terminal, it is nearly impossible to additionally arrange the functional elements for smoothly performing the various functions required for a current trend of the ‘portable multi media complex machine’, as long as the size of the terminal is not further increased.

### SUMMARY OF THE INVENTION

Accordingly, the present invention has been developed to sufficiently reflect needs that should be prepared for a terminal. An object of the present invention is to separate a body of a mobile communication terminal into two body parts connected to be rotatable in a horizontal direction by a predetermined angle so that a user can crook the linear type terminal and thus change the terminal into a form suited for the user's taste. In addition, another object of the invention is to diversely embody functions of the terminal by providing an extended body portion, which is generated after the rotation of the predetermined angle, as an additional area in which accessories can be mounted.

In order to achieve the above objects, there is provided a mobile communication terminal comprising: first and second body connected to be rotatable in a horizontal direction by a predetermined angle; an extended part formed protrudingly from one of surfaces opposite to each other of the first and second bodies and exposed when the first and second bodies are rotated and then located at an opening position, thereby providing an area in which an accessory can be mounted; and a receiving part formed on the other of the surfaces opposite to each other of the first and second bodies and receiving the extended part when the first and second bodies are rotated and then located at a closing position.

According to an embodiment of the invention, the first and second bodies may be connected by a hinge shaft and rotated in a horizontal direction by a predetermined angle, and the surfaces, on which the extended part and the receiving part are opposite to each other, may be formed with catching projections to prevent the first and second bodies from being rotated beyond the predetermined angle. In addition, the surfaces, on which the extended part and the receiving part are opposite to each other, may be formed with a guide rail and a guide recess corresponding to each other to guide the rotating movements of the first and second bodies.

In the mean time, according to the invention, the first and second bodies may comprise an upper cover an a lower cover connected to each other, respectively, and the upper cover or lower cover of one of the first and second bodies may be provided with a first guide plate and the lower cover or upper cover of the other of the first and second bodies may be provided with a second guide plate so that the first and second guide plates can be moved with being abutted on each other. At this time, surfaces, on which the first and second guide plates are abutted, may be formed with a guide rail and a guide recess corresponding to each other so as to guide the rotating movements of the first and second bodies.

According to an embodiment of the invention, the hinge parts of the first and second bodies may further comprise a cam device, so that a user can feel a moderate feeling (braking force) when the first and second bodies reach the closing or opening position.

According to an embodiment of the invention, the cam device may comprise a first cam plate included in the hinge part of the first body and rotating with the first body; a second cam plate included in the hinge part of the second body so as to abut on the first cam plate and rotating with the second body; a housing formed in the hinge part of the second body and receiving the second cam plate such that the second cam plate cannot rotate therein but move in a direction parallel with the hinge shaft; and an elastic member in the housing elastically biasing the second cam plate toward the first cam plate. According to an embodiment of the invention, one of the surfaces on which the first and second cam plates are abutted may be formed with two cam grooves corresponding to an angle between the closing position and the opening position of the first and second bodies and the other surface may be formed with a cam protrusion inserted into the cam groove, so that the user can feel the moderate feeling when the cam protrusion is inserted into the cam grooves by an elastic force of the elastic member while the first and second bodies rotate.

### BRIEF DESCRIPTION OF THE DRAWINGS

The above and other objects, features and advantages of the present invention will be more apparent from the following detailed description taken in conjunction with the accompanying drawings, in which:

FIG. 1 an exploded perspective view showing a mobile communication terminal according to a preferred embodiment of the invention;

FIG. 2 is a plan view showing an assembled state of the terminal according to an embodiment of the invention;

FIG. 3A is a sectional view taken along a line of 3A-3A in FIG. 2;

FIG. 3B is a sectional view taken along a line of 3B-3B in FIG. 2;

FIG. 4 is a plan view showing a state that first and second bodies are rotated according to an embodiment of the invention;

FIG. 5 is an exploded plan view showing a state that a mobile communication terminal is separated, according to another embodiment of the invention;

FIG. 6A is a view showing that the mobile communication terminal shown in FIG. 5 is connected;

FIG. 6B is a sectional view taken along a line of 6B-6B in FIG. 6A;

FIG. 6C is a sectional view taken along a line of 6C-6C in FIG. 6B;

FIG. 7A schematically shows that a mobile communication terminal according to another embodiment of the invention is located at a closing position;

FIG. 7B is a partial sectional view taken along a line of 7B-7B in FIG. 7A;

FIG. 7C schematically shows that the mobile communication terminal of FIG. 7A is located at an opening position; and

FIG. 7D is a partial sectional view taken along a line of 7D-7D in FIG. 7C.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

In the drawings, although a ‘bar type’ mobile communication terminal is described as an example, it should be noted that the invention can be applied to a main body part of a folder type terminal and a main body part of a slide type terminal as well as the bar type terminal.

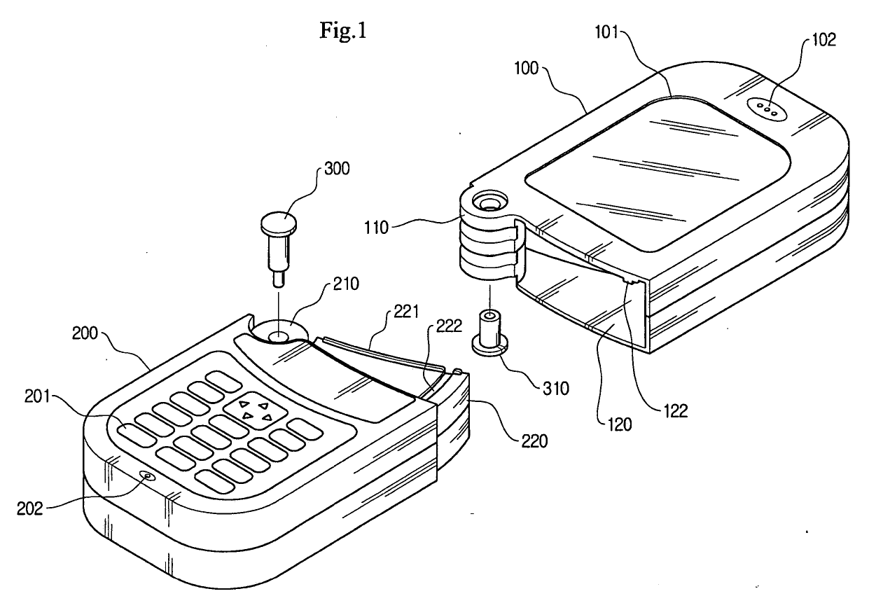

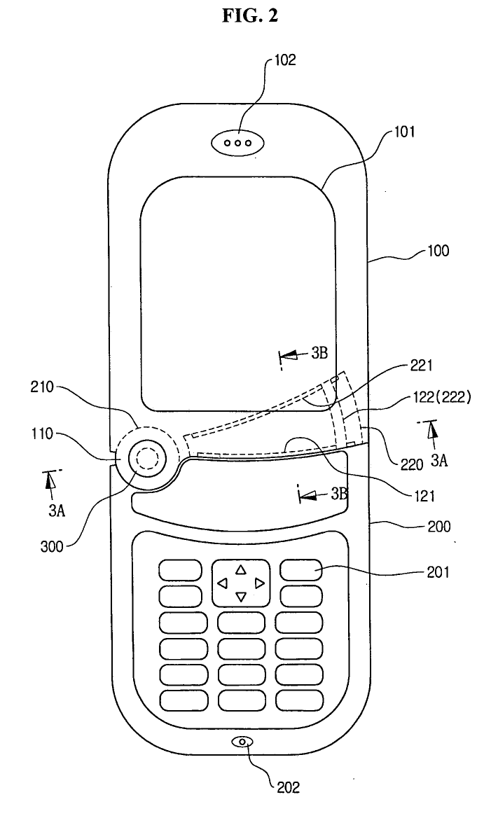

FIGS. 1 and 2 show a mobile communication terminal according to a preferred embodiment of the invention, wherein FIG. 1 shows a state that the mobile communication terminal is separated and FIG. 2 shows that the mobile communication terminal is assembled, so that a first body 100 and a second body 200 are located at a closing position.

Referring to FIGS. 1 and 2, a mobile communication terminal according to a preferred embodiment of the invention comprises a first body 100 and a second body 200, which is separated into two parts.

The separated first and second bodies 100, 200 are connected to be rotatable in a horizontal direction by a predetermined angle with hinge shafts 300, 310. Specifically, one side of the first body 100 and the second body 200 is formed with hinge parts 110, 210. The hinge parts 110, 210 are protrudingly formed to pass each other, so that they are inserted to abut and overlap with each other. When the hinge parts 110, 210 are overlapped each other, the hinge shafts 300, 310 art inserted into the hinge parts 110, 210 and connect with them, so that the first and second bodies 100, 200 can rotate about the hinge shafts 300, 310.

In addition, one of surfaces opposite to each other of the first and second bodies 100, 200 is protrudingly formed with an extended part 220. According to this embodiment, the extended part 220 is extended from the second body 200. Correspondingly to this, the first body 100 is formed with a receiving part 120 into which the extended part 220 is selectively received.

Accordingly, according to the invention, it is possible to use the terminal with the first and second bodies 100, 200 being crooked by rotating the bodies in a horizontal direction by a predetermined angle. In addition, when the first and second bodies 100, 200 are rotated and then located at an opening position, the extended part 220 is exposed to an exterior, so that it is possible to additionally mount functional elements, which are required for a use of the terminal, to the extended part 220 exposed.

In order to limit the rotating angles of the first and second bodies 100, 200, the surfaces opposite to each other of the extended part 220 and the receiving part 120 are formed with catching projections 121, 221. The catching projections 121, 221 may be formed on either or both upper and lower surfaces opposite to each other of the extended part 220 and the receiving part 120. In the FIG. 2, it is shown that the catching projections 121, 221 are formed on the upper surfaces only.

In the mean time, in order to stably guide the rotations of the first and second bodies 100, 200, the extended part 220 and the receiving part 110 are formed with a guide rail 122 and a guide recess 222 corresponding to each other. The guide rail 122 and the guide recess 222 may be formed on either or both upper and lower surfaces opposite to each other of the receiving part 120 and the extended part 220. In the FIGS. 1 and 2, it is shown that the guide rail 122 and the guide recess 222 are formed on the upper surfaces only.

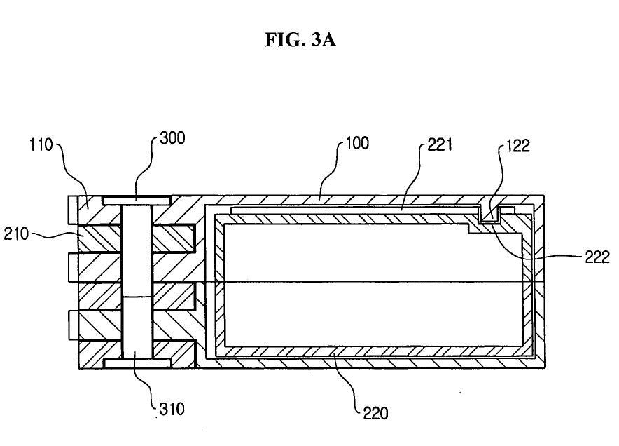

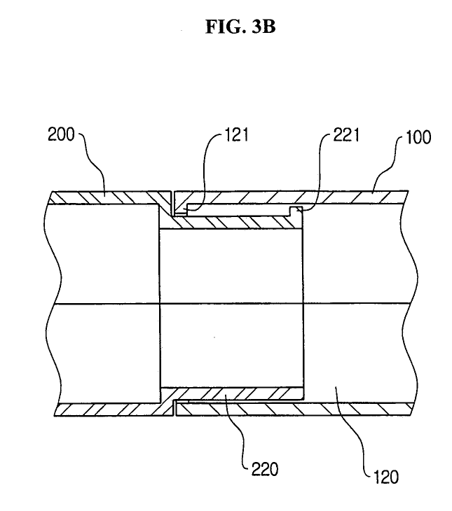

FIG. 3A is a sectional view taken along a line of 3A-3A in FIG. 2 and shows the hinge parts 110, 210 in detail.

Referring to FIG. 3A, the hinge parts 110, 210 formed at the first and second bodies 100, 200 are inserted to be rotatable while overlapping with each other and the hinge shafts 300, 310 pass through the hinge parts 110, 210 to connect with them, under such state. In addition, the guide rail 122 is inserted into the guide recess 222, thereby guiding the rotations of the first and second bodies 100, 200 about the hinge shafts 300, 310.

FIG. 3B is a sectional view taken along a line of 3B-3B in FIG. 2, and shows the shapes of the catching projections 121, 221 in detail.

Referring to FIG. 3B, the catching projections 121, 221 are respectively formed to the first body 100 and the extended part 220 of the second body 200. Since FIG. 3B shows that the extended part 220 is inserted into the receiving part 120 of the first body 100, the catching projections 121, 221 maintain their spaced state. Under this state, when the first and second bodies 100, 200 are rotated, the catching projections 121, 221 approach and are caught with each other, so that the rotations of the first and second bodies 100, 200 are stopped at a predetermined angle.

The mobile communication terminal of the invention structured as described above makes a linear form at ordinary times as shown in FIG. 2, in which the terminal is situated at a closing position since the first and second bodies 100, 200 does not rotate. Under this state, when the first and second bodies 100, 200 are rotated, they are situated at an opening position and make a crooked form.

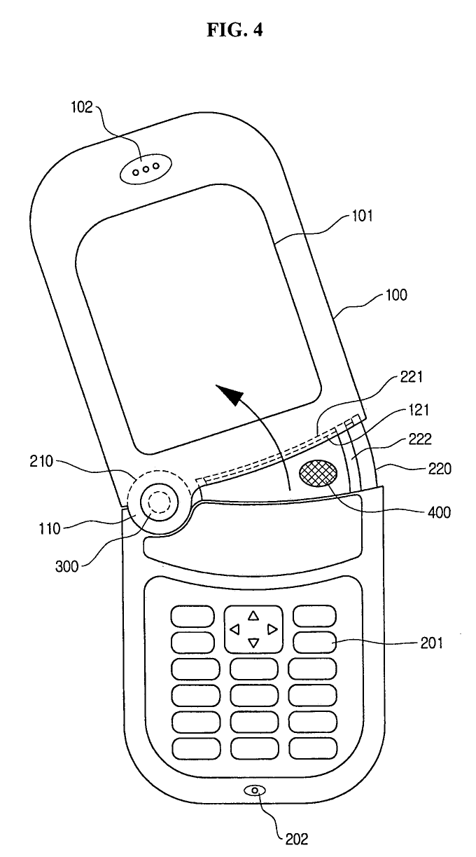

In other words, as shown in FIG. 4, when the first and second bodies 100, 200 are rotated to be situated at the opening position, they make a form crooked into a ‘banana’ shape and the extended part 220 protruded from the second body 200 is exposed. The extended part 220 exposed provides an additional area to which accessories assisting the functions of the terminal can be further mounted. For example, as shown in FIG. 4, it is possible to improve a multi media function of the terminal by mounting a speaker 400 to an upper (front) surface of the extended part 220. The accessories include a key button, a camera and the like in addition to the speaker 400 shown in FIG. 4, and at least one of them can be mounted to the area.

In addition, it is possible to mount the accessories to a back (rear) surface of the extended part 220 as well as the upper (front) surface thereof. An example of an accessory that is suitable for being mounted to the back surface of the extended part 220 is a heat-radiating fan(not shown). When the heat-radiating fan is mounted, it is possible to prevent an overheating of the terminal by releasing the heat, which occurs from an inside of the terminal, to the exterior and to prevent a thermal damage of the built-in parts of the terminal.

In the mean time, as described above, when the terminal of the invention is a bar-type terminal, as shown in FIGS. 1 and 4, it is possible to arrange a LCD screen 101 on the first body 100 and input key buttons 201 on the second body 200. The speaker 102 and a mike 202 may be mounted to the first body 100 and the second body 200, respectively, like the prior art.

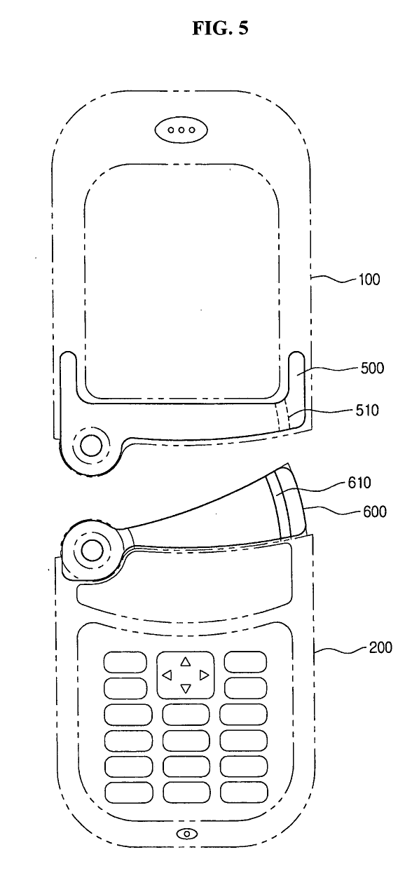

FIG. 5 is an exploded plan view of a mobile communication terminal according to another embodiment of the invention.

Referring to FIG. 5, a first guide plate 500 is mounted to one of the first and second bodies 100, 200 and a second guide plate 500 is additionally mounted to the other body. The first and second guide plates 500, 600 move with being abutted on each other. The remaining structures are same as the above-described embodiment, except the guide plates 500, 600 and an auxiliary hinge device which will be described later. The auxiliary hinge device will be more specifically described later.

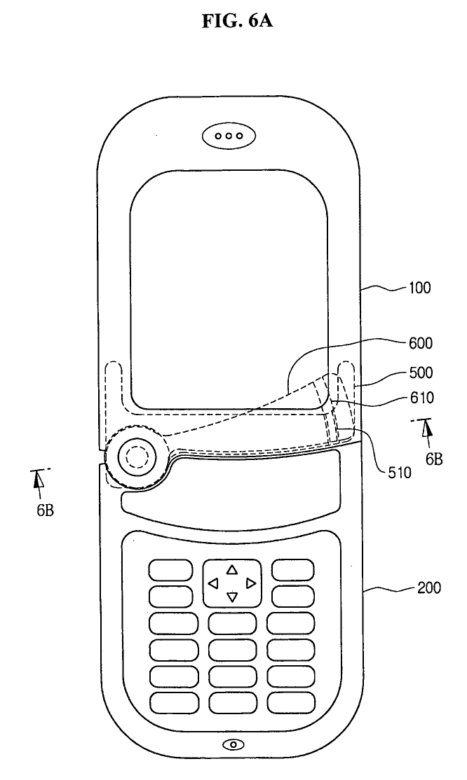

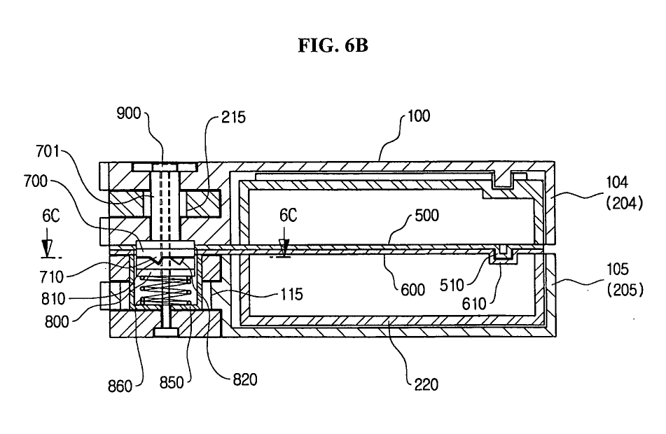

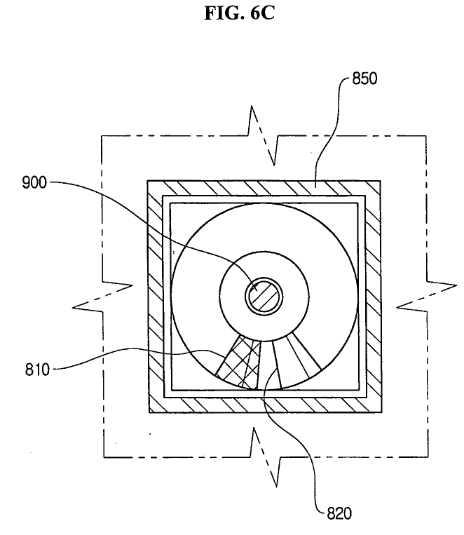

FIG. 6A is a plan view showing a state that the first and second bodies 100, 200 comprising the first and second guide plates 500, 600 are assembled.

Referring to FIG. 6A, since the first and second guide plates 500, 600 are surface-contacted to each other, they are rotated with being abutted on each other when the first and second bodies 100, 200 are rotated. The first and second guide plates 500, 600 allow the first and second bodies 100, 200 to be rotated more stably and prevent the first and second bodies 100, 200 from being directly contacted to each other and thus worn when the first and second bodies 100, 200 are rotated. Accordingly, it is preferred that the first and second guide plates 500, 600 are made of a metal material or high strength plastic having a hardness higher than the first and second bodies 100, 200.

In the mean time, the surfaces, on which the first and second guide plates 500, 600 abut each other, are preferably formed with a guide rail 510 and a guide recess 610 corresponding to each other, thereby guiding the first and second bodies 100, 200 to be stably rotated.

Under assembled state as shown in FIG. 6A, the first and second guide plates 500, 600 are overlapped each other and the guide rail 510 is inserted into the guide recess 610 to connect with them.

FIG. 6B is a sectional view taken along a line of 6B-6B in FIG. 6A, and shows a mounted form of the first and second guide plates 500, 600.

Typically, the first and second bodies 100, 200 comprise an upper cover 104, 204 and a lower cover 105, 205 connected to each other, respectively. The first and second guide plates 500, 600 according to this embodiment are preferably mounted along a dividing surface of the upper cover 104, 204 and the lower cover 105, 205. In other words, the first guide plate 500 is mounted to a lower surface of the upper and lower dividing surface of the upper cover 104 of the first body 100 and the second guide plate 600 is mounted to an upper surface of the upper and lower dividing surface of the lower cover 205 of the second body 200, so that the first and second guide plates 500, 600 are rotated while being surface-contacted to each other. In addition, the guide rail 510 and the guide recess 610 formed on the first and second guide plates 500, 600, respectively, guide the rotations of the first and second guide plates 500, 600.

In the mean time, FIG. 6C is a sectional view taken along a line of 6C-6C in FIG. 6B and shows an auxiliary hinge device included in a mobile communication terminal according to another embodiment of the invention, together with FIG. 6B.

Referring to FIGS. 6B and 6C, the auxiliary hinge device is a cam device and serves to allow the user to feel the moderate feeling (braking force) indicating that the first and second bodies 100, 200 reach the closing or opening position when the user rotates the first and second bodies 100, 200.

Specifically, the cam device comprises first and second cam plates 700, 800. The first and second cam plates 700, 800 are opposite to each other at the hinge parts 110, 210 of the first and second bodies 100, 200 and are rotated together with the first and second bodies 100, 200, respectively. In the embodiment shown in FIGS. 6B and 6C, the first cam plate 700 is inserted into the hinge part 110 of the first body 100 through a shaft 701 having a square cross section, and rotated with the first body 100. The hinge part 210 of the second body 200 is formed with a second releasing groove 215, thereby allowing the hinge part 210 to be freely rotated without interfering with the shaft 701 having a square cross section. The second cam plate 800 is received in a housing 850 formed in the hinge part 210 of the second body 200 and having a square cross section so that it cannot rotate but move in a direction parallel with a hinge shaft 900. The housing 850 has a square cross section and is formed to be integrated with the second body 200 and the hinge part 110 of the first body 100 is formed with a first releasing groove 115, thereby allowing the hinge part 110 to be rotated without interfering with the housing 850.

Of the first and second cam plates 700, 800, the second cam plate 800 received in the housing 850 is elastically pressed toward the opposite first cam plate 700 by an elastic member 860.

In addition, one of the surfaces opposite to each other of the first and second cam plates 700, 800 is formed with two cam grooves 810, 820 and the other surface is formed with a cam protrusion 710. The two cam grooves 810, 820 are formed to correspond to an angle between the closing position and the opening position of the first and second bodies 100, 200. As the first and second bodies 100, 200 are situated at the closing or opening position, the cam protrusion 710 is inserted into one of the two cam grooves 810, 820.

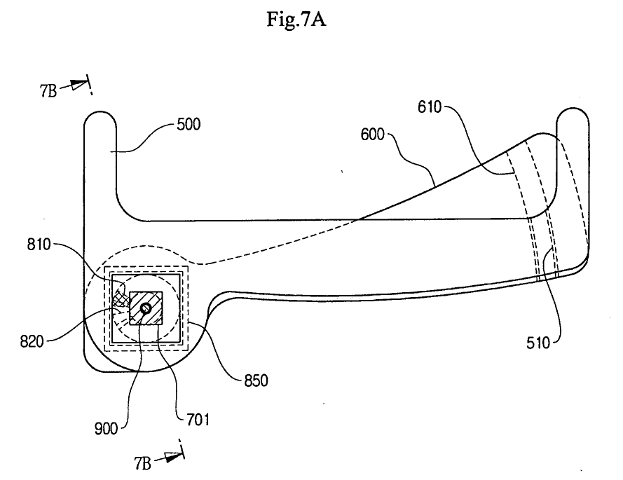

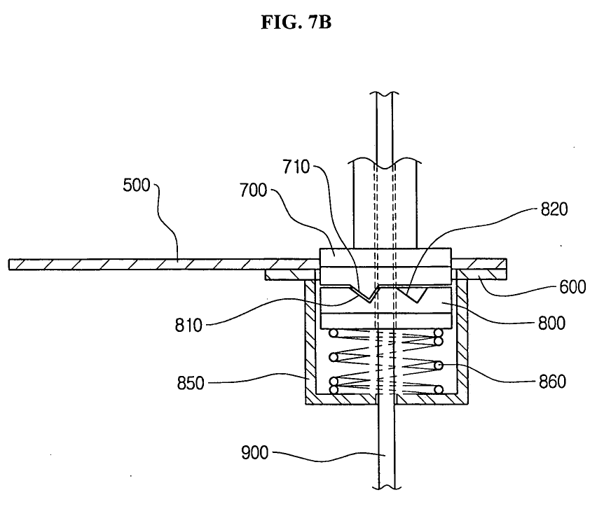

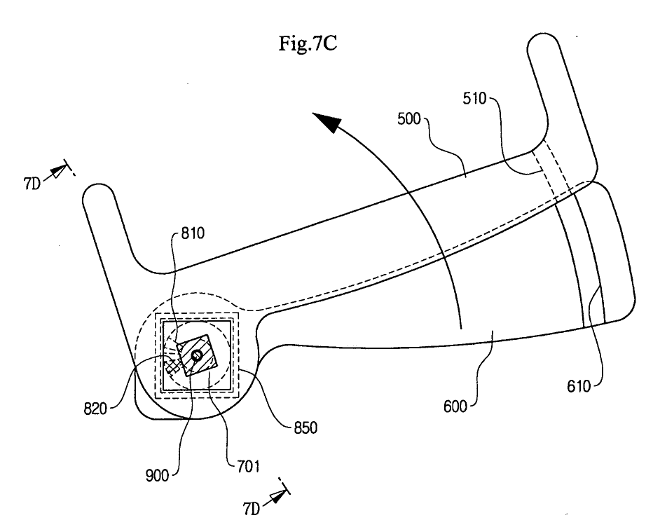

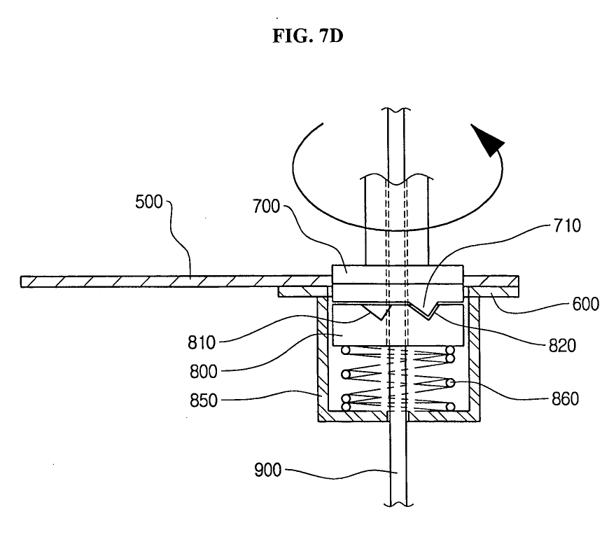

FIGS. 7A to 7D show operations of the cam device structured as described above. FIG. 7A shows that the first and second bodies 100, 200 are situated at the closing position, and FIG. 7B is a partial sectional view taken along a line of 7B-7B in FIG. 7A. Also, FIG. 7C shows that the first and second bodies 100, 200 are situated at the opening position, and FIG. 7D is a partial sectional view taken along a line of 7D-7D in FIG. 7C.

In FIGS. 7A to 7D, the first and second bodies 100, 200 are omitted, the first guide plate 500 is shown instead the first body 100 and the second guide plate 600 is shown instead the second body 200. Accordingly, it can be considered the first guide plate 500 as the first body 100 and the second guide plate 600 as the second body 200.

Referring to FIGS. 7A and 7B, when the first and second bodies 100, 200 are situated at the closing position and thus the first and second guide plates 500, 600 are overlapped each other, the cam protrusion 710 of the first cam plate 700 is inserted into the first cam groove 810 of the second cam plate 800.

FIGS. 7C and 7D show that the first and second bodies 100, 200 are rotated from the closing position to the opening position. In other words, when the first cam plate 700 is rotated in an arrow direction by the rotation of the first body 100, the cam protrusion 710 of the first cam plate 700 pushes the second cam plate 800 to compress the elastic member 860 so as to escape from the first cam groove 810 of the second cam plate 800. In this case, a repulsive force resulting from the compression of the elastic member 860 is delivered to a hand of the user, so that the user can feel an ‘operating feeling’.

Then, when the first body 100 reaches the opening position after the cam protrusion 710 of the first cam plate 700 is escaped from the first cam groove 810 of the second cam plate 800, the cam protrusion 710 of the first cam plate 700 is elastically inserted into the second cam groove 820 of the second cam plate 800. Thereby, the second cam plate 800 is raised by the elastic force of the elastic member 860 and caught while producing a sound of click. In this case, the user can be delivered with a fresh feeling indicating that a moderate operation has been done, together with a feeling indicating that the first body 100 is completely opened.

As described above, according to the invention, the mobile communication terminal is separated into two body parts having functions different from each other and the two body parts are connected to be rotatable in a horizontal direction by a predetermined angle.

Accordingly, it is possible to crook to use the prior rectangular linear terminal, so that a user can change the terminal into a form suited for the user's taste.

In addition, since it is possible to mount the functional elements, which are auxiliary or requisite for the use of the terminal, to the extended body part resulting from the rotations of the two body parts, the functions of the terminal can be embodied more diversely and the terminal can be used more conveniently.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A mobile communication terminal comprising:
first and second bodies connected to be rotatable in a horizontal direction by a predetermined angle;
an extended part protrudingly formed from one of surfaces opposite to each other of the first and second bodies and exposed when the first and second bodies are rotated and then located at an opening position, thereby providing an area in which an accessory can be mounted; and
a receiving part formed on the other of the surfaces opposite to each other of the first and second bodies and receiving the extended part when the first and second bodies are rotated and then located at a closing position.

2. The terminal as claimed in claim 1, wherein the first and second bodies have a hinge part, respectively, and a hinge shaft is inserted into the hinge part, so that the first and second bodies are connected to be rotatable in a horizontal direction by a predetermined angle

3. The terminal as claimed in claim 1, wherein surfaces, on which the extended part and the receiving part are opposite to each other, are respectively formed with a catching projection to prevent the first and second bodies from being rotated beyond the predetermined angle.

4. The terminal as claimed in claim 1, wherein surfaces, on which the extended part and the receiving part are opposite to each other, are formed with a guide rail and a guide recess guiding the rotating movements of the first and second bodies so as to correspond to each other.

5. The terminal as claimed in claim 1, wherein the first and second bodies comprise an upper cover and a lower cover connected to each other, respectively, and the upper cover or lower cover of one of the first and second bodies is provided with a first guide plate and the lower cover or upper cover of the other of the first and second bodies is provided with a second guide plate, so that the first and second guide plates are moved with being abutted on each other.

6. The terminal as claimed in claim 5, wherein surfaces, on which the first and second guide plates are abutted each other, are formed with a guide rail and a guide recess guiding the rotating movements of the first and second bodies so as to correspond to each other.

7. The terminal as claimed in claim 2, wherein the hinge parts of the first and second bodies further comprise a cam device allowing a user to feel a moderate feeling (braking force) when the first and second bodies reach the closing or opening position.

8. The terminal as claimed in claim 7, wherein the cam device comprises a first cam plate included in the hinge part of the first body and rotating with the first body;
a second cam plate included in the hinge part of the second body so as to abut on the first cam plate and rotating with the second body;
a housing formed in the hinge part of the second body and receiving the second cam plate such that the second cam plate cannot rotate therein but move in a direction parallel with the hinge shaft; and
an elastic member in the housing elastically biasing the second cam plate toward the first cam plate,
wherein one of the surfaces, on which the first and second cam plates are abutted, is formed with two cam grooves corresponding to an angle between the closing position and the opening position of the first and second bodies and the other surface is formed with a cam protrusion inserted into the cam groove, so that the user can feel the moderate feeling when the cam protrusion is inserted into the cam grooves by an elastic force of the elastic member while the first and second bodies rotate.

9. The terminal as claimed in claim 1, wherein the terminal is a bar-type terminal, one of the first and second bodies is mounted with at least LCD screen and the other body is mounted with input key buttons consisting of at least number keys.

10. The terminal as claimed in claim 1, wherein the accessory comprises at least one of a speaker, a key button, a camera and a heat-radiating fan.
